(19) United States
(12) Patent Application Publication
(10) Pub. No.: US 2002/0103662 A1
(43) Pub. Date: Aug. 1, 2002

(54) Facilitation of transactions between early stage companies and product /service vendors through an intermediary

(76) Inventors: Kurt E. English, Newport Beach, CA (US); James W. Casparie, Anaheim, CA (US); John P. Garcia, Tustin, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 10/012,733

(22) Filed: Nov. 5, 2001

Related U.S. Application Data
(60) Provisional application No. 60/245,972, filed on Nov. 3, 2000.

(51) Int. Cl. G06F 17/60

(52) U.S. Cl. 705/1

(57) ABSTRACT

A business entity serves as an intermediary that facilitates transactions between early stage companies and product/service vendors. In accordance with a preferred method, the intermediary solicits information from a company based upon which the intermediary makes an impartial creditworthiness and viability analysis of the company. The intermediary then provides the analysis to the company as well as to product and service vendors that may be of interest to the company. The intermediary may also perform introductions between the company and potential vendors. The product and service vendors can use the analysis to make determinations as to whether to extend credit to the company in exchange for products and/or services. The product and service vendors may alternatively or additionally decide to take an equity interest in the company in exchange for products and services.

### RELATED APPLICATIONS

This application claims the benefit of U.S. Provisional Application No. 60/245,972, filed on Nov. 3, 2000, which is hereby incorporated by reference.

### BACKGROUND OF THE INVENTION

Product and service vendors, such as business service vendors, technology service vendors, financial service vendors, and raw product vendors oftentimes provide products and services on credit or other terms to established companies with established credit or operating histories. Many established companies also have the ability to finance products and services through alternative financing avenues or other programs. Oftentimes however, these financing, credit, and other options may not be available to early stage companies. An early stage company may still have a high negative cash flow, may have insufficient credit or no credit based upon which to make purchases of products or services needed during a startup and/or growth phase, or may have an insufficient operating history to entice vendors to provide favorable terms.

### SUMMARY OF THE INVENTION

In accordance with the present invention, a business entity serves as an intermediary that facilitates transactions between early stage companies and product/service vendors.

In accordance with a preferred method, the intermediary solicits information from a company based upon which the intermediary makes an impartial creditworthiness and viability analysis of the company. The intermediary then provides the analysis to the company as well as to product and service vendors that may be of interest to the company. The intermediary may also perform introductions between the company and potential vendors. The product and service vendors can use the analysis to make determinations as to whether to extend credit to the company in exchange for products and/or services. The product and service vendors may alternatively or additionally decide to take an equity interest in the company in exchange for products and services.

In one embodiment, the intermediary preferably charges fees to the company in exchange for its services. The fees may alternatively or additional be charged to the product/service providers. The analysis of the company may be a manual analysis conducted by trained financial analysts, may be an automated analysis, or may be a combination of both manual and automated procedures.

In one embodiment, the intermediary offers its services and solicits most or all of the information from companies through a web site.

### BRIEF DESCRIPTION OF THE DRAWINGS

FIGS. 1 through 15 illustrate web pages of a web site according to one embodiment of the invention.

FIG. 16 illustrates a method in accordance with one embodiment of the invention.

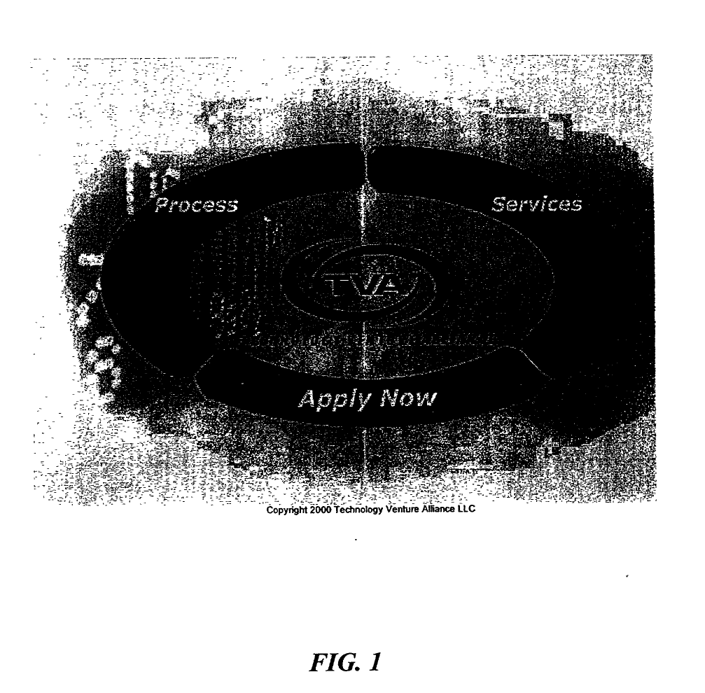

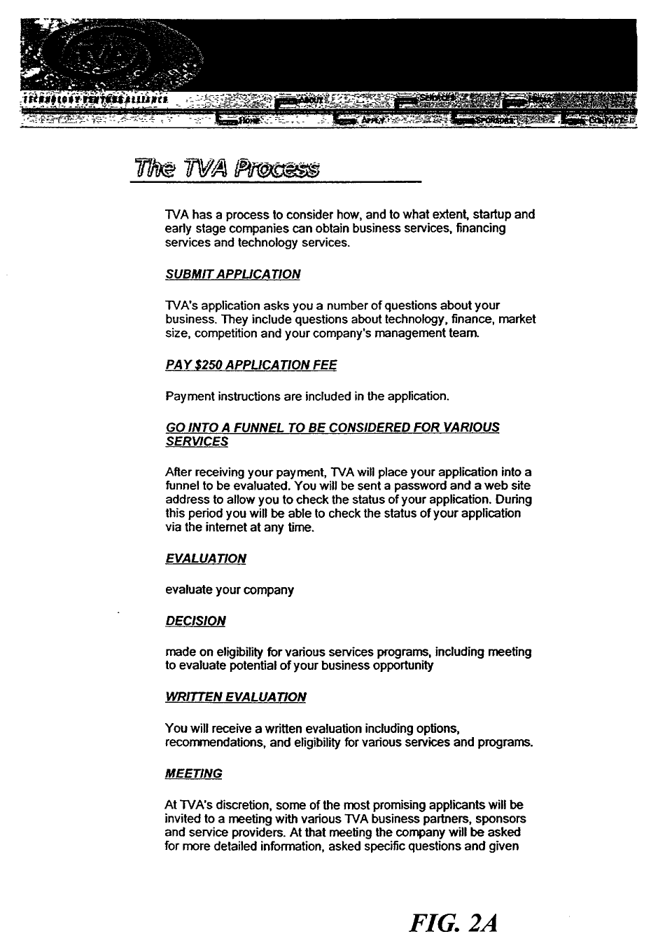

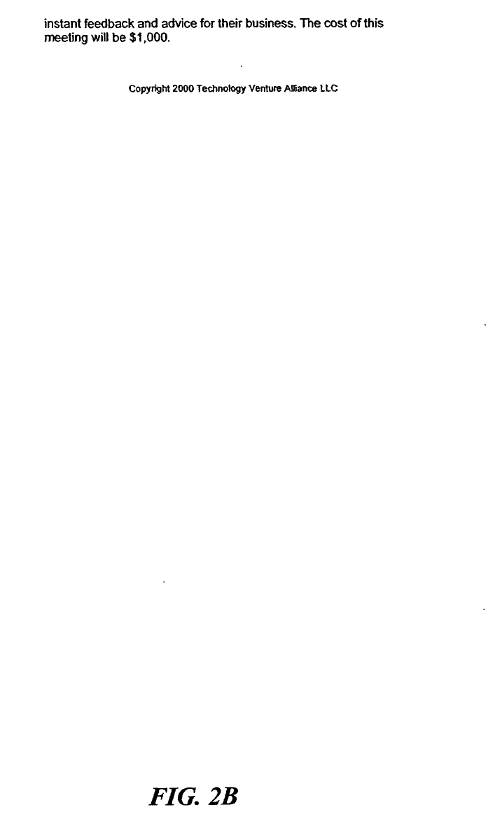

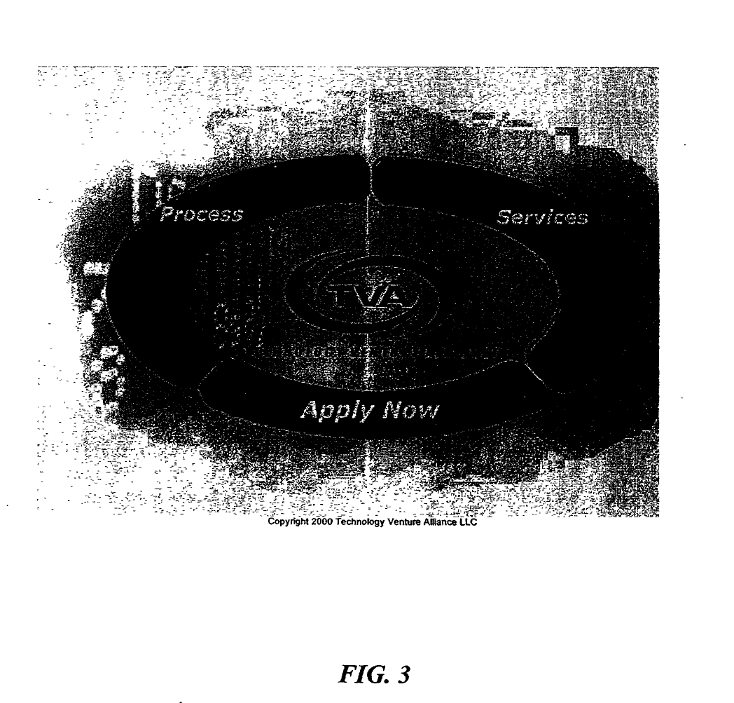

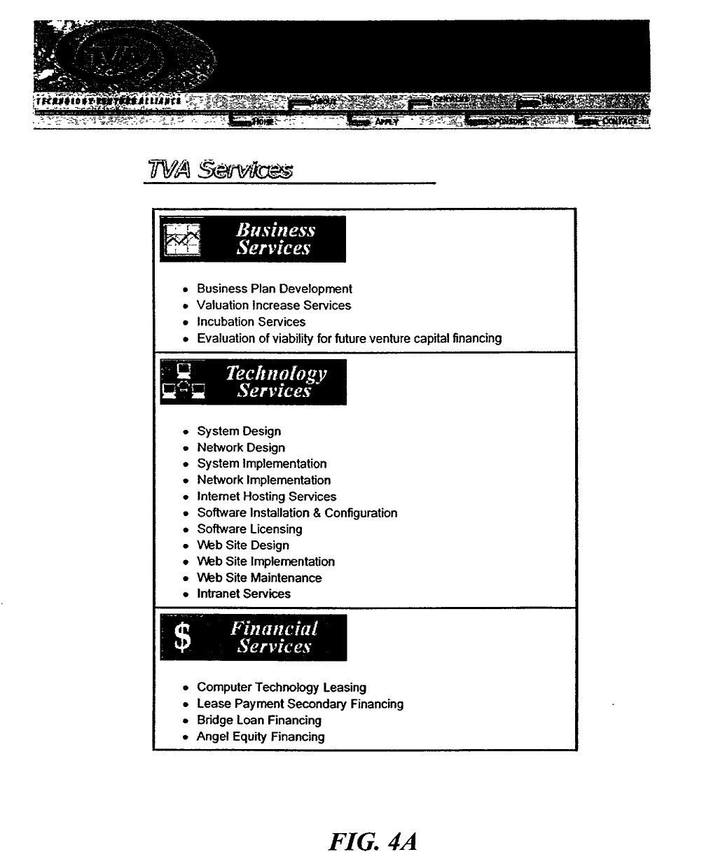

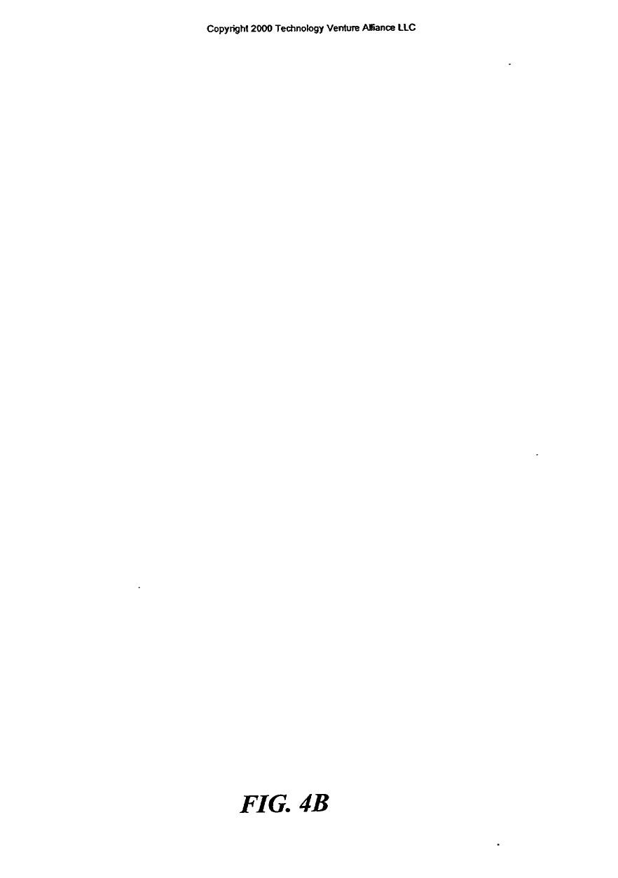

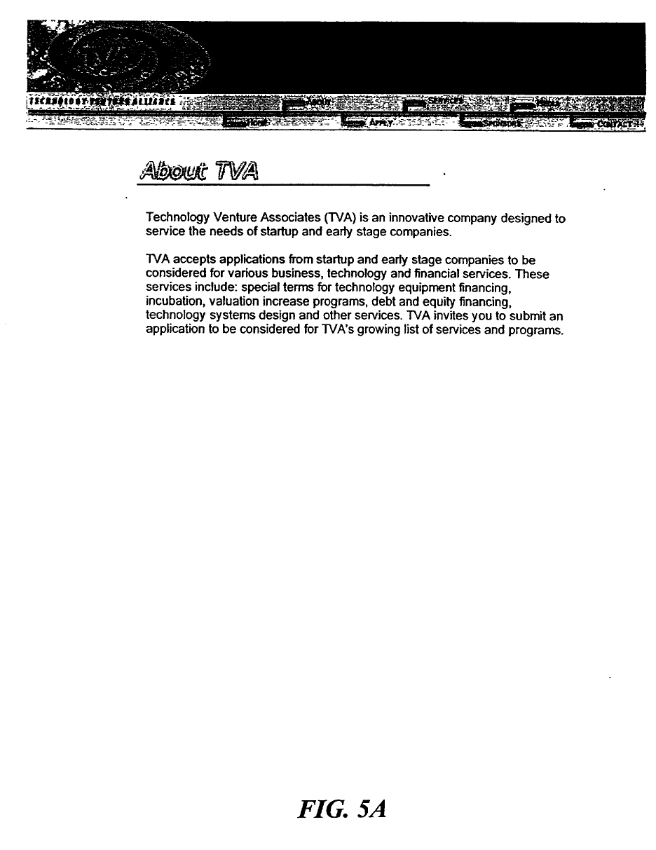

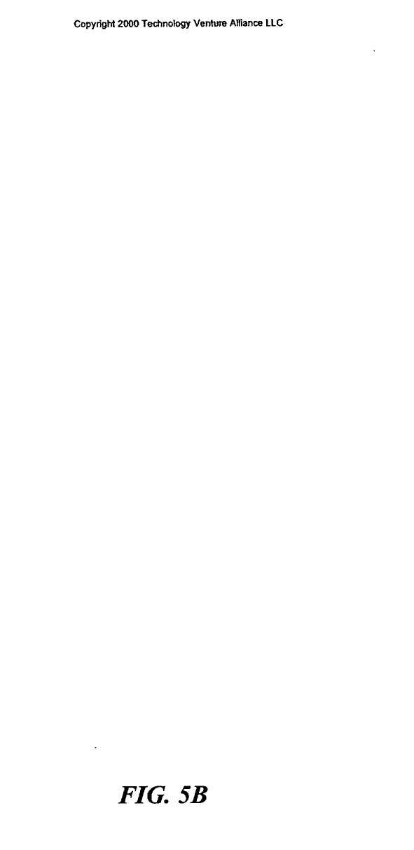

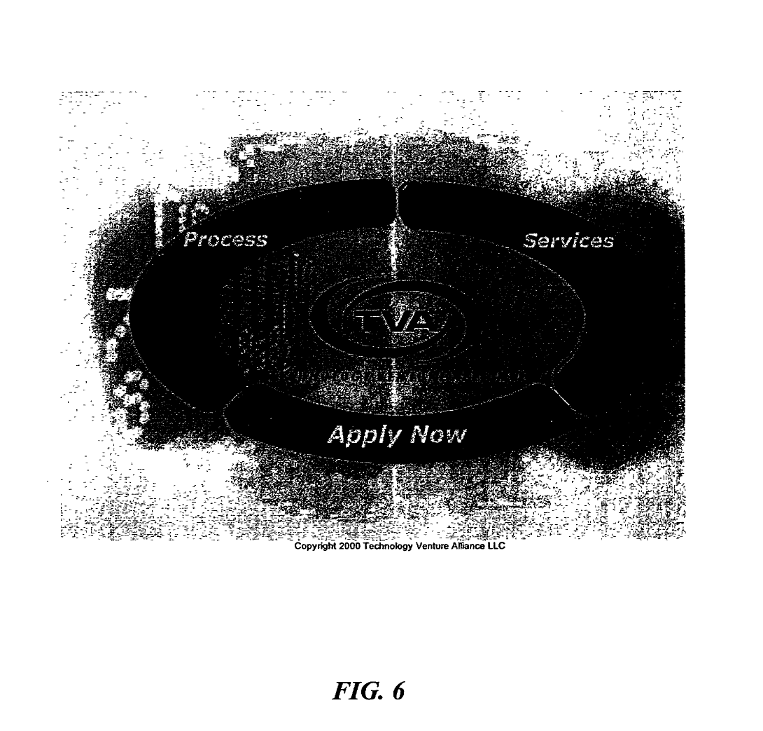

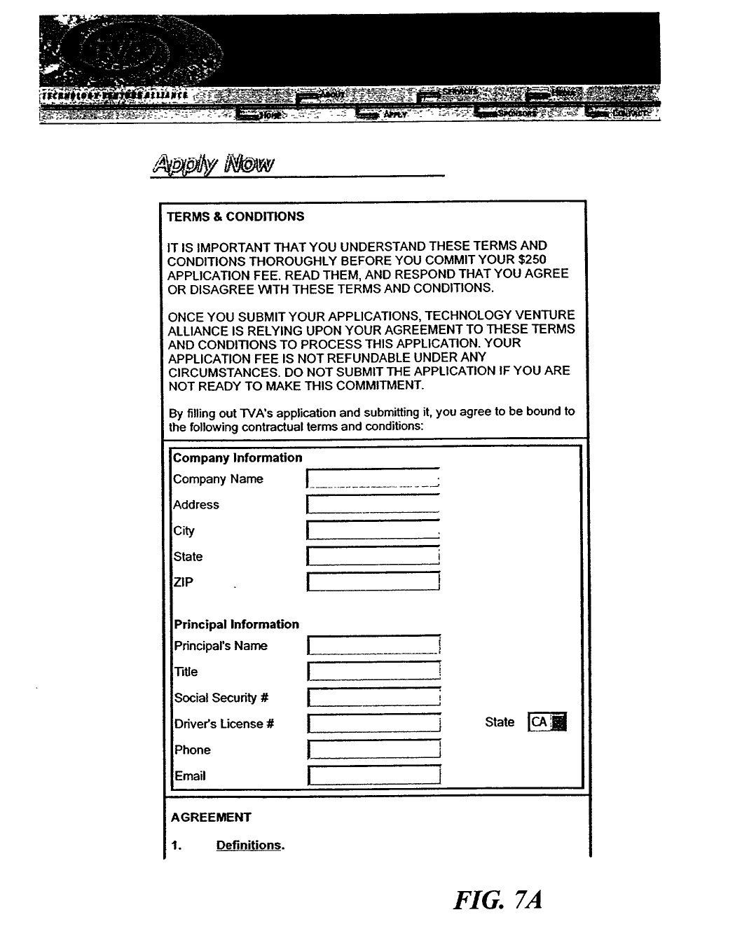

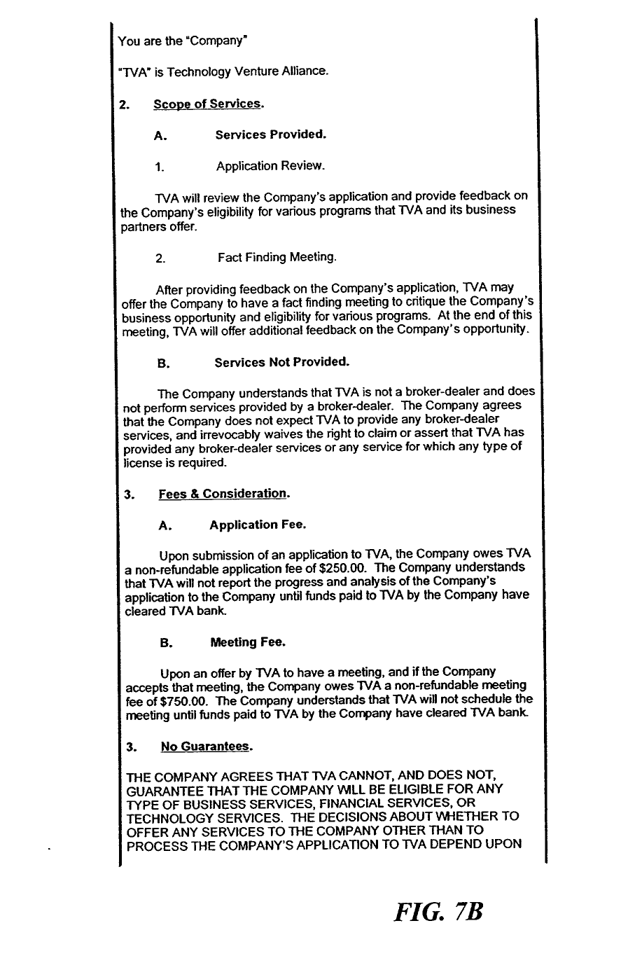

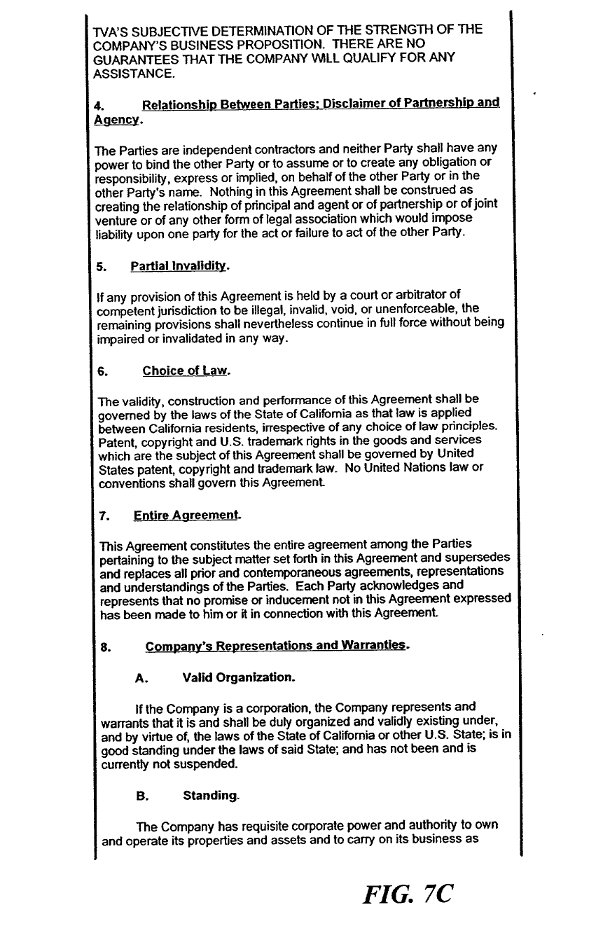

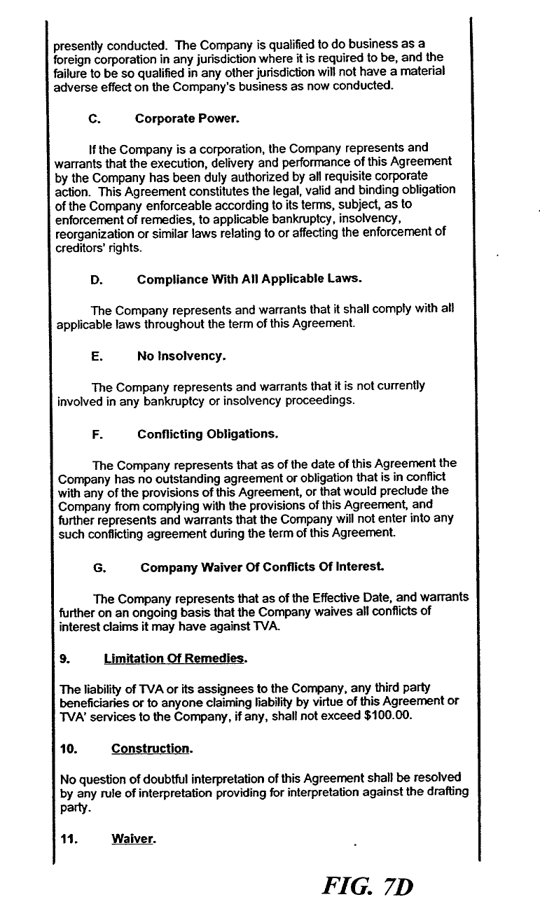

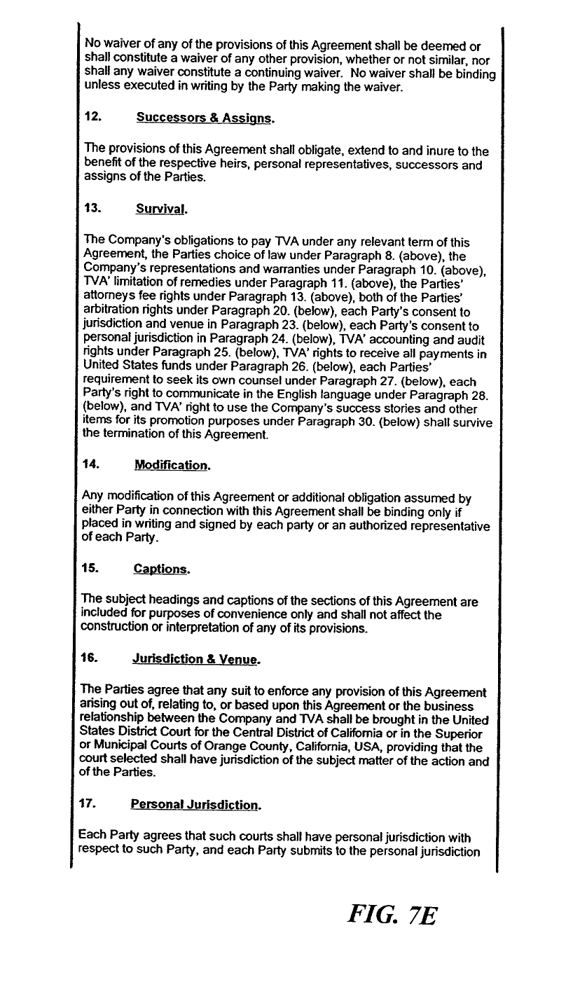

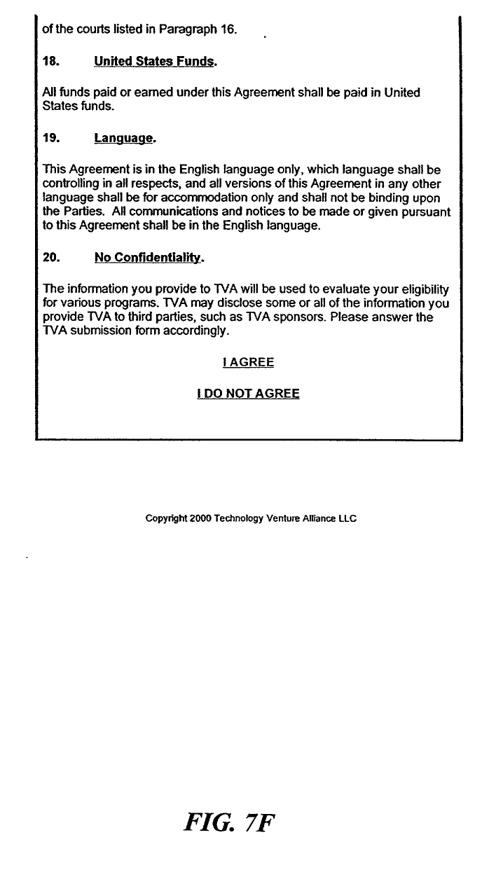

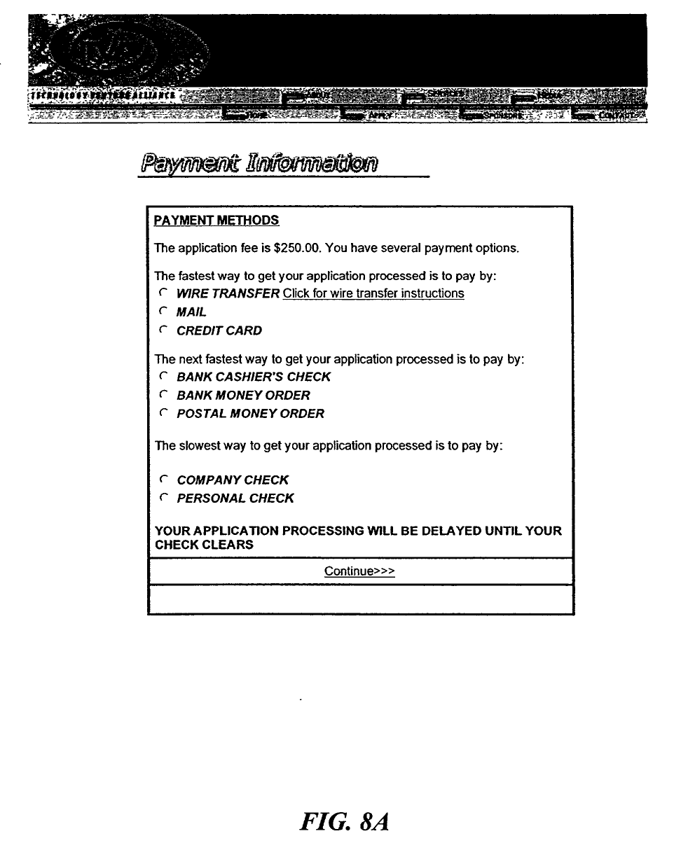

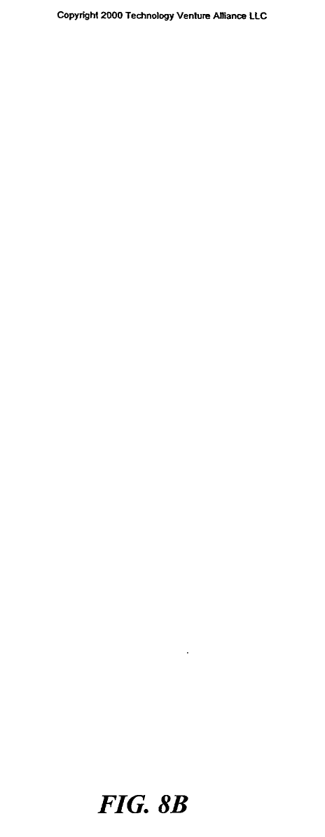

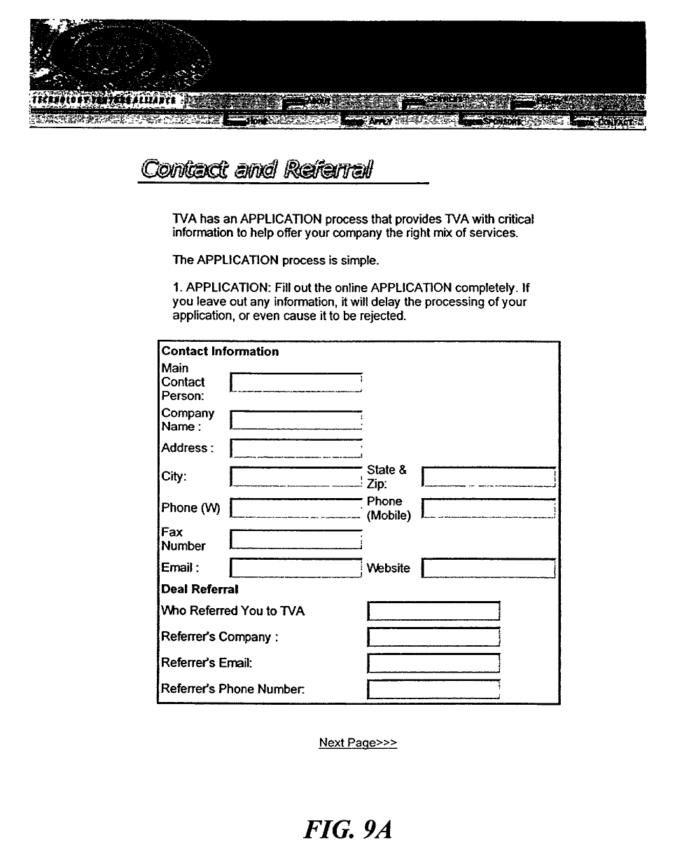

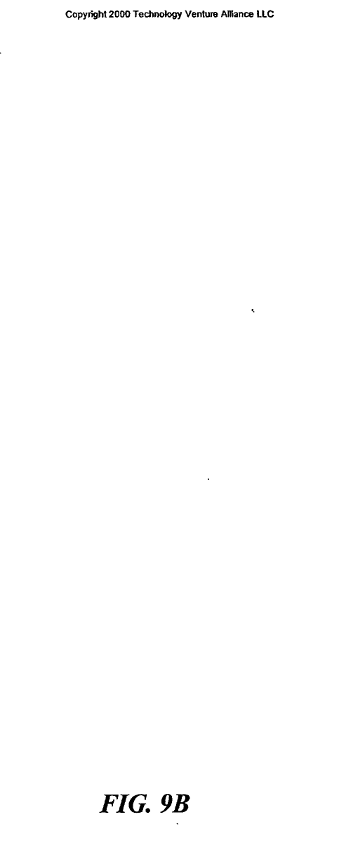

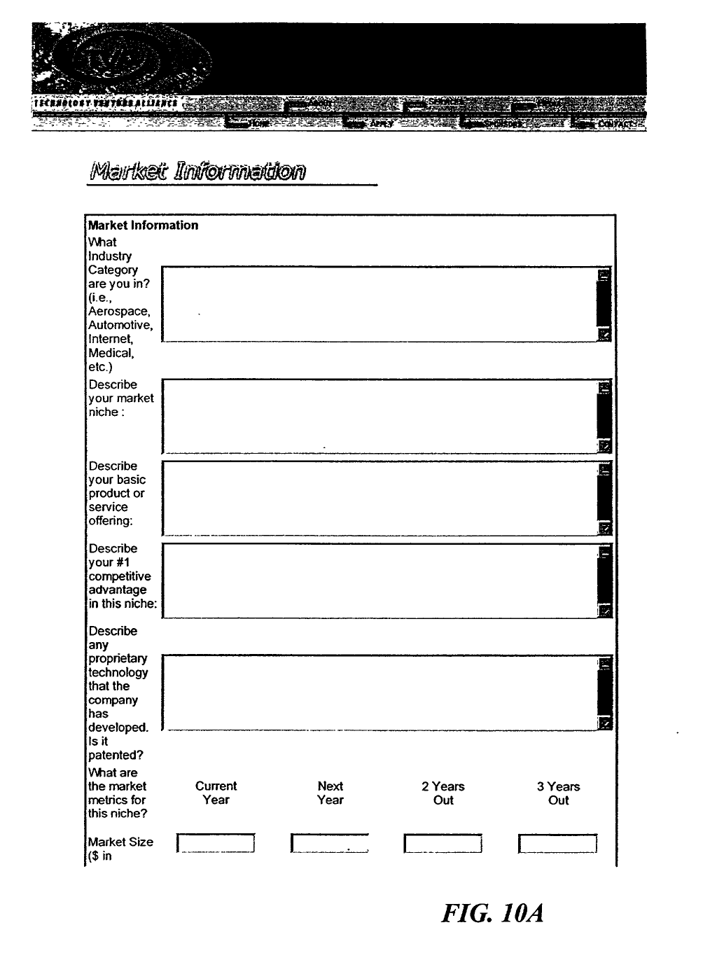

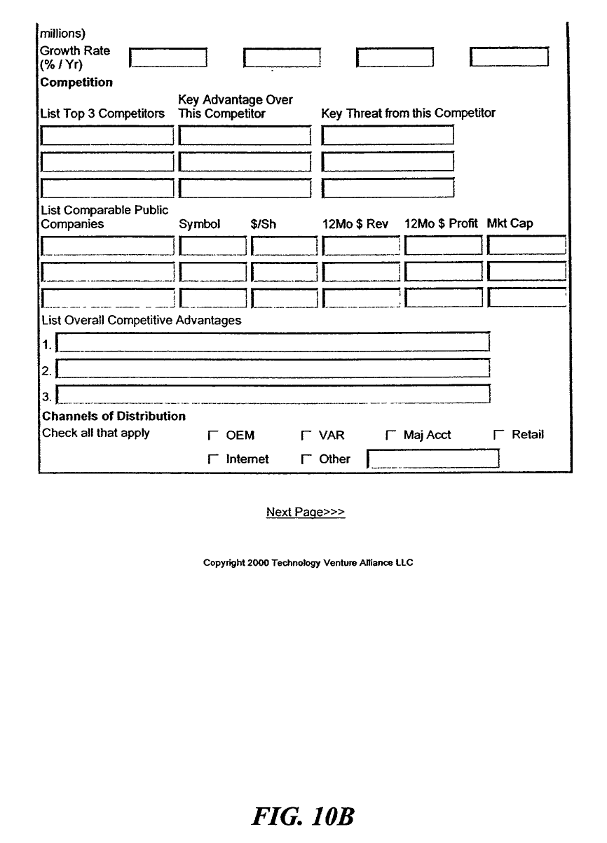

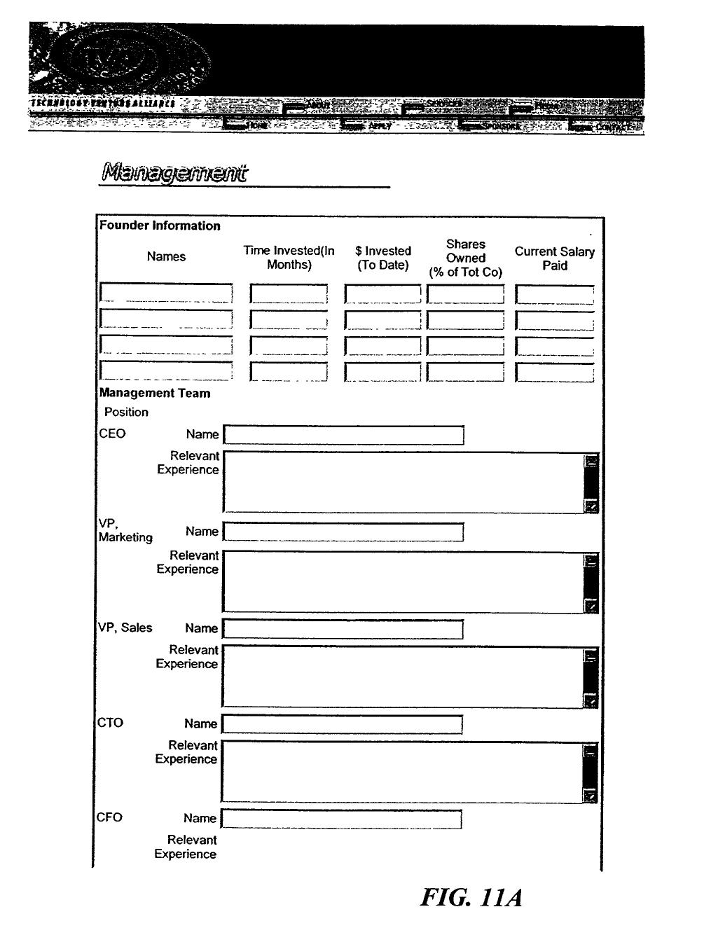

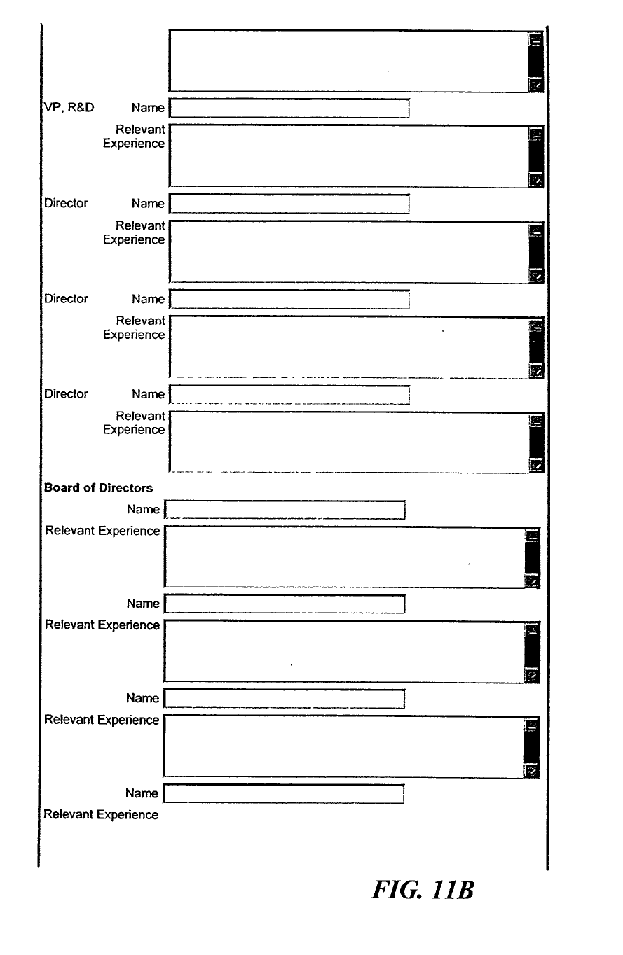

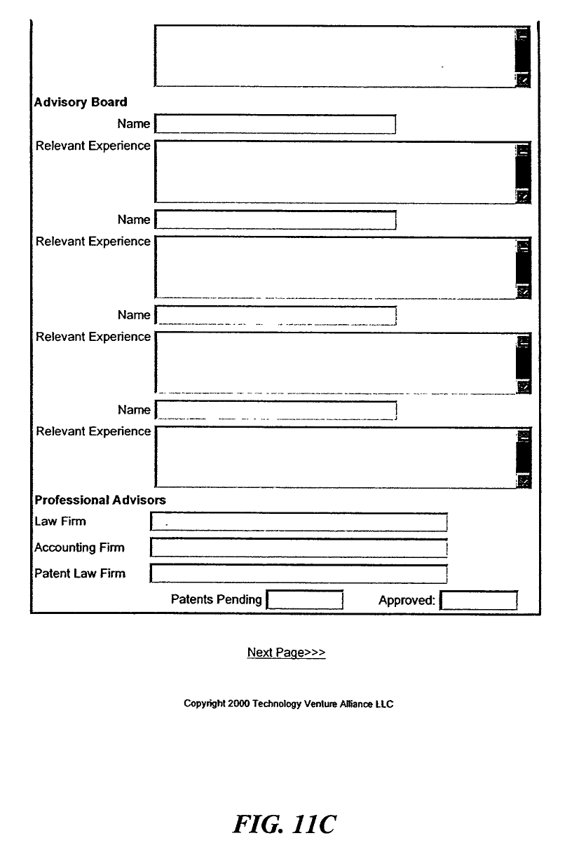

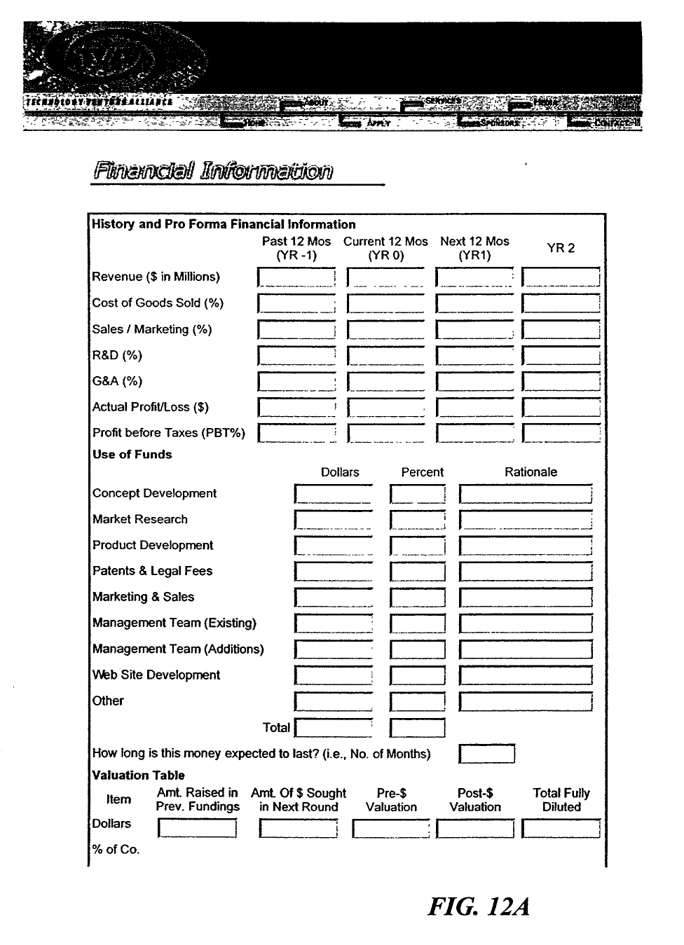

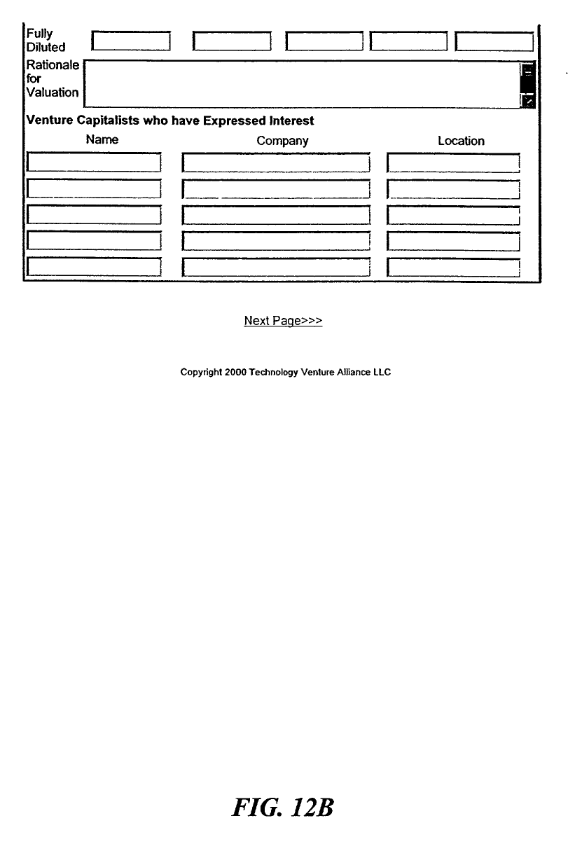

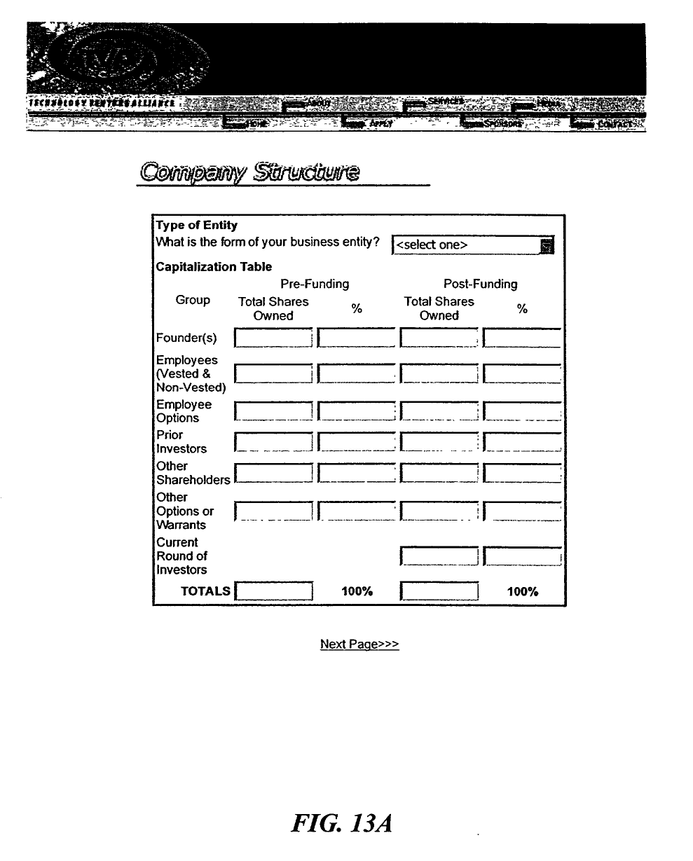

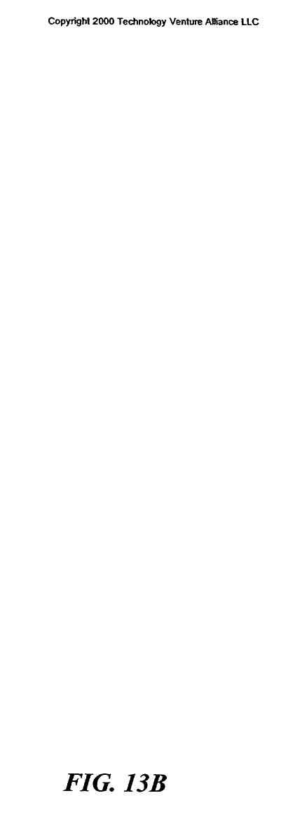

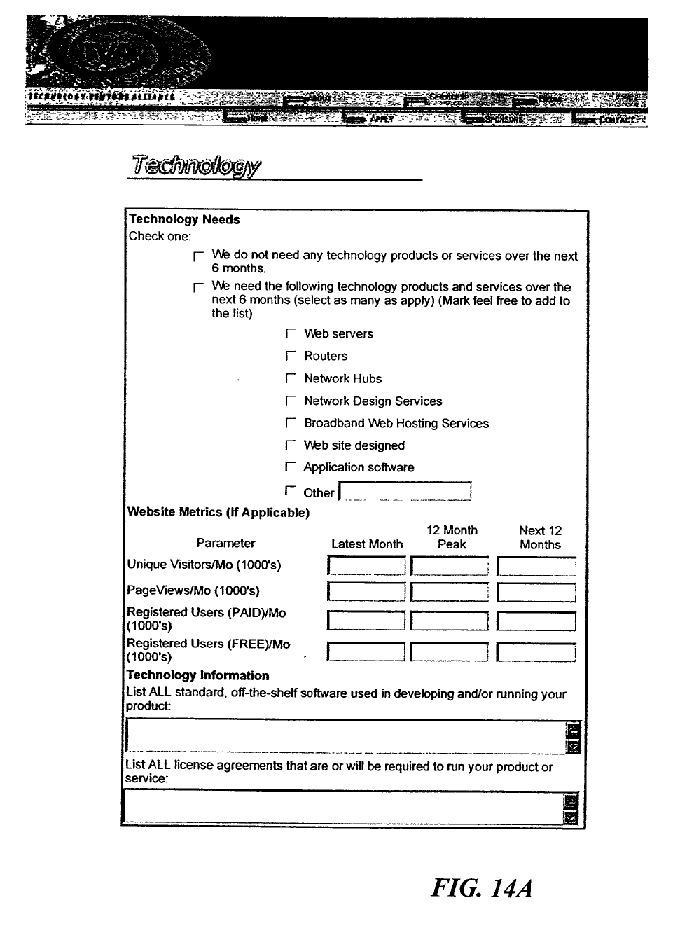

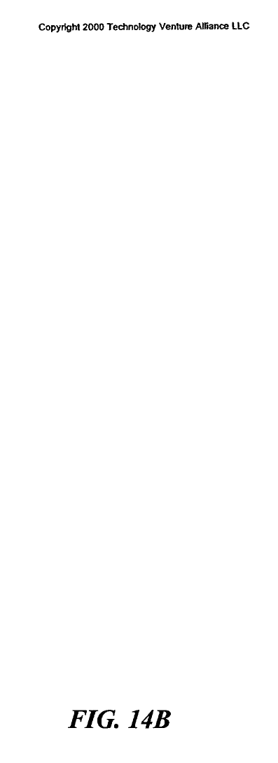

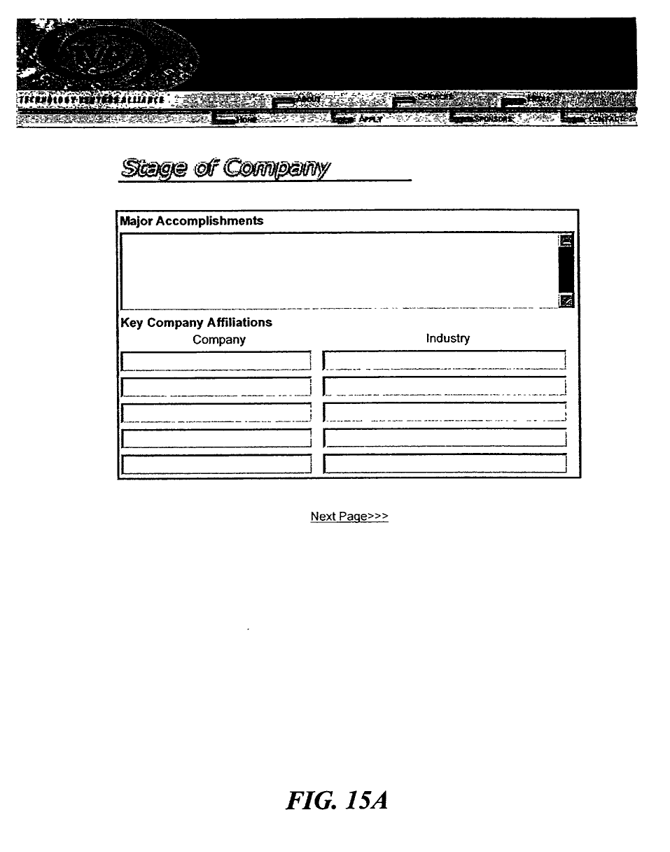

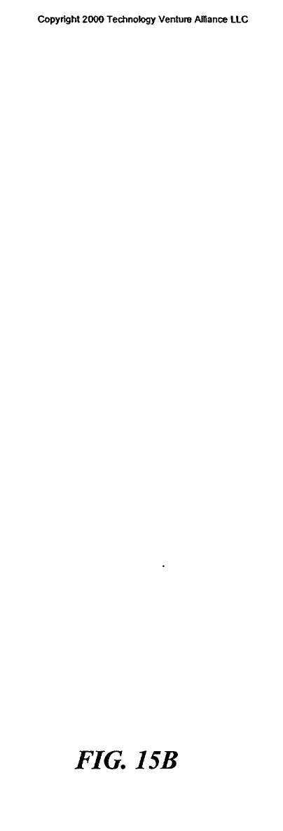

### DETAILED DESCRIPTION

Referring to FIG. 16, an intermediary preferably performs a process 1600 through which it facilitates transactions between early stage companies and product/service vendors. The intermediary can be a business entity such as, for example, a corporation, a partnership, or an individual.

At a step 1602, the entity receives information from a company seeking services. The services can include, for example, business services, technology services, or financial services. The received information can include, for example, market information, founder information, financial information, company structure, company needs, or company accomplishments.

At a step 1604 the entity performs an evaluation of the company based at least upon the received information. The evaluation can be performed manually, using known financial and other analysis techniques. Alternatively, the evaluation can be performed, at least in part, using automated techniques.

At a step 1606, the entity creates a report based at least upon the evaluation. At a step 1608, the entity provides the report to at least one service provider capable of providing services that the company is seeking.

At a step 1610, the entity receives a fee from the company in exchange for performing the steps 1604, 1606 and 1608.

Although the invention has been described in terms of certain embodiments, other embodiments that will be apparent to those of ordinary skill in the art, including embodiments which do not provide all of the features and advantages set forth herein, are also within the scope of this invention. In method claims, reference characters are used for convenience of description only, and do not indicate a particular order for performing a method.

What is claimed is:

1. A method comprising:
(a) receiving information from a company seeking services;
(b) performing an evaluation of the company based at least upon the received information;
(c) creating a report based at least upon the evaluation;
(d) providing the report to at least one service providers capable of providing at least a portion of the services; and
(e) receiving a fee from the company in exchange for performing (b), (c), and (d).

2. The method of claim 1, wherein at least one of the service providers is a business service provider.

3. The method of claim 1, wherein at least one of the service providers is a technology service provider.

4. The method of claim 1, wherein at least one of the service providers is a financial service provider.

5. The method of claim 1, wherein at least one of the service providers provides a service selected from the group consisting of: business plan development, valuation increasing services, incubation services, and evaluation of viability for future venture capital financing.

6. The method of claim 1, wherein at least one of the service providers provides a service selected from the group consisting of: system design, network design, system implementation, network implementation, internet hosting services, software installation and configuration, software licensing, web site design, web site implementation, web site maintenance, and intranet services.

7. The method of claim 1, wherein at least one of the service providers provides a service selected from the group consisting of: computer technology leasing, lease payment secondary financing, bridge loan financing, and angel equity financing.

8. The method of claim 1, wherein the received information comprises market information for the company.

9. The method of claim 1, wherein the received information comprises founder information for the company.

10. The method of claim 1, wherein the received information comprises financial information for the company.

11. The method of claim 1, wherein the received information comprises company structure information.

12. The method of claim 1, wherein the received information comprises technology needs information for the company.

13. The method of claim 1, wherein the received information comprises accomplishments of the company.
